(19) United States
(12) Patent Application Publication
(10) Pub. No.: US 2026/0371067 A1
(43) Pub. Date: Nov. 19, 2026

(54) CAPABILITY EXCHANGE FOR NON-TERRESTRIAL NETWORKS

(71) Applicant: AT&T Intellectual Property I, L.P., Atlanta, GA (US)

(72) Inventors: Sreejith Menon, Chantilly, VA (US); Suja John, Herndon, VA (US)

(73) Assignee: AT&T Intellectual Property I, L.P., Atlanta, GA (US)

(21) Appl. No.: 19/208,771

(22) Filed: May 15, 2025

(51) Int. Cl. H04W 8/24; H04W 60/00; H04W 84/06

(52) U.S. Cl. CPC H04W 8/24; H04W 60/00; H04W 84/06

(57) ABSTRACT

Aspects of the subject disclosure may include, for example, a device comprising: a processing system including a processor; and a memory that stores executable instructions that, when executed by the processing system, facilitate performance of operations, the operations comprising: receiving, from a wireless device, a request including first capability information, wherein the first capability information includes a satellite-specific communication capability of the wireless device; and transmitting, to the wireless device, a message in accordance with the first capability information. Other embodiments are disclosed.

### FIELD OF THE DISCLOSURE

The subject disclosure relates to capability exchange in non-terrestrial networks (NTNs).

### BACKGROUND

Non-Terrestrial Networks (NTNs) refer to communication networks that extend beyond traditional terrestrial infrastructure, utilizing technologies such as satellites, high-altitude platforms (HAPs), and unmanned aerial vehicles (UAVs) to provide connectivity. These networks are designed to offer wireless communication services in areas where building terrestrial infrastructure is impractical or cost-prohibitive, such as remote, rural, and underserved regions. NTNs play a crucial role in expanding global connectivity, supporting applications that require seamless communication across diverse environments, including the Internet of Things (IoT), autonomous vehicles, and remote monitoring systems. In combination with existing terrestrial networks, NTNs aim to deliver comprehensive coverage and enhance the overall communication experience for users worldwide.

Efforts are underway to standardize NTN technologies and ensure interoperability with terrestrial networks. Organizations like the 3rd Generation Partnership Project (3GPP) are working on defining standards for NTN communication, including satellite direct-to-cellular implementations. Regulatory bodies are also addressing spectrum allocation and usage policies to support the deployment of NTNs.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a communications network in accordance with various aspects described herein.

FIG. 1B is a block diagram illustrating an exemplary, non-limiting embodiment of a system in accordance with various aspects described herein.

FIG. 2A is a block diagram illustrating an example, non-limiting embodiment of a communications system in accordance with various aspects described herein.

FIG. 2B is a signaling flow diagram illustrating an example, non-limiting embodiment of a communication procedure for signaling non-terrestrial capability information, in accordance with various aspects described herein. The

FIG. 2C is a flow chart illustrating an example, non-limiting embodiment of a method in accordance with various aspects described herein.

FIG. 2D is a flow chart illustrating an example, non-limiting embodiment of a method in accordance with various aspects described herein.

FIG. 2E is a flow chart illustrating an example, non-limiting embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for signaling non-terrestrial capability information. Other embodiments are described in the subject disclosure.

One or more aspects of the subject disclosure include a device comprising: a processing system including a processor; and a memory that stores executable instructions that, when executed by the processing system, facilitate performance of operations, the operations comprising: receiving, from a wireless device, a request including first capability information, wherein the first capability information includes a satellite-specific communication capability of the wireless device; and transmitting, to the wireless device, a message in accordance with the first capability information.

One or more aspects of the subject disclosure include a non-transitory machine-readable medium, comprising executable instructions that, when executed by a processing system including a processor, facilitate performance of operations, the operations comprising: receiving, from a wireless device, a request including a first data field and a second data field, wherein the first data field includes a non-terrestrial communication capability of the wireless device and the second data field includes a terrestrial communication capability of the wireless device; and transmitting, to a non-terrestrial network device, a message according to the non-terrestrial communication capability of the wireless device, wherein the non-terrestrial network device is configured to relay the message to the wireless device.

One or more aspects of the subject disclosure include a method comprising: transmitting, by a wireless device, a request including a first capability information of the wireless device associated with non-terrestrial communications and a second capability information of the wireless device associated with terrestrial communications; and receiving, by the wireless device, a communication from a satellite based on the first capability information.

In recent years, the field of wireless communications has expanded to include Non-Terrestrial Networks (NTNs), which utilize satellite, high-altitude platforms, and unmanned aerial vehicles to provide connectivity in areas where terrestrial infrastructure is impractical or cost-prohibitive. These networks play an important role in extending global connectivity, particularly in remote and underserved regions. However, integrating NTNs with existing terrestrial networks presents significant challenges, particularly in terms of capability exchange and network optimization.

Current systems typically incorporate general capability information during initial access procedures, which is insufficient for accommodating both terrestrial and satellite communication requirements. This generalized signaling can lead to ambiguous interpretations of the operating environment, resulting in inefficient resource allocation and limited performance optimization. The lack of detailed indicators specific to satellite operations hinders precise management of network behavior and resource utilization, complicating the application of appropriate access controls and performance optimizations.

The present technology addresses these challenges by introducing signaling for communicating User Equipment (UE) capabilities specific to satellite communication. This approach allows for more precise and effective management of UEs on Non-Terrestrial Networks (NTNs), ensuring improved performance and user experience. Embodiments of the present technology separate satellite capability information from other UE capability exchange information, enabling the network to distinguish between capabilities for terrestrial and satellite networks. For example, this separation is important for aspects like security algorithms, which commonly require increased stringency for satellite communication due to the involvement of third-party satellite providers.

By incorporating specific satellite capabilities into the UE's capability information, networks can better manage and optimize satellite communication, leading to improved performance and user experience. Embodiments of the present technology include a call flow that includes both UE capability exchange and satellite capability exchange, allowing the network to make informed decisions based on the device's capabilities on both terrestrial and satellite networks. This ensures efficient handover and service optimization when transitioning between network types, providing a flexible and dynamic approach to managing satellite communication capabilities.

It should be understood that aspects of the present technology are variously discussed in the context of 4G, 5G, and 3rd Generation Partnership Project (3GPP) standards. However, the principles and methods disclosed herein are applicable to a wide range of communication networks and are not limited to 3GPP networks. The technology is adaptable to any network architecture or protocol that includes capability exchange and non-terrestrial networks, regardless of the specific standards or terminology employed.

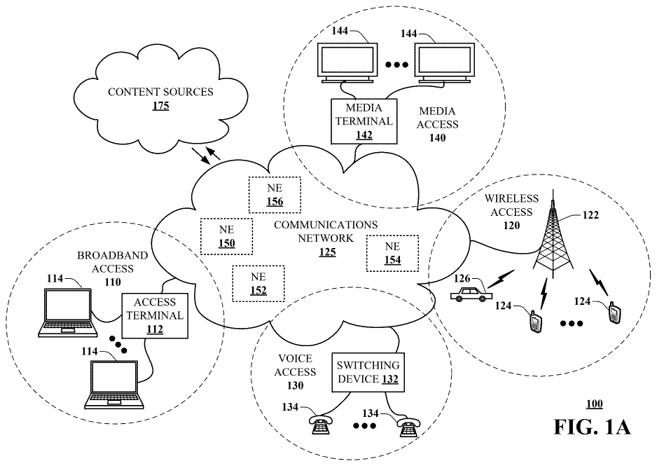

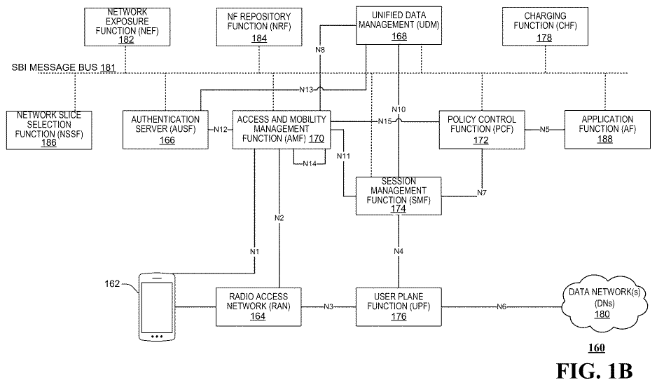

Referring now to FIG. 1A, a block diagram is shown illustrating an example, non-limiting embodiment of a system 100 in accordance with various aspects described herein. For example, system 100 can facilitate in whole or in part exchange of satellite-specific capability information. In particular, a communications network 125 is presented for providing broadband access 110 to a plurality of data terminals 114 via access terminal 112, wireless access 120 to a plurality of mobile devices 124 and vehicle 126 via base station (BS) or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, Ultra Wideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Referring now to FIG. 1B, a block diagram is shown illustrating an example, non-limiting embodiment of a system in accordance with various aspects described herein. FIG. 1B illustrates an architecture 160 including 5G core network functions (NFs) that can facilitate in whole or in part exchange of satellite-specific capability information. For example, the architecture 160 can be included as a core network of the communications network 125.

A wireless device 162 (e.g., device 124) can access the 5G network (e.g., network 125) through a NAN (e.g., gNB) of a RAN 164. The NFs include an Authentication Server Function (AUSF) 166, a Unified Data Management (UDM) 168, an Access and Mobility management Function (AMF) 170, a Policy Control Function (PCF) 172, a Session Management Function (SMF) 174, a User Plane Function (UPF) 176, and a Charging Function (CHF) 178.

The interfaces N1 through N15 define communications and/or protocols between each NF as described in relevant standards. The UPF 176 is part of the user plane and the AMF 170, SMF 174, PCF 172, AUSF 166, and UDM 168 are part of the control plane. One or more UPFs can connect with one or more data networks (DNs) 180. The UPF 176 can be deployed separately from control plane functions. The NFs of the control plane are modularized such that they can be scaled independently. As shown, each NF service exposes its functionality in a Service Based Architecture (SBA) through a Service Based Interface (SBI) 181 that uses HTTP/2. The SBA can include a Network Exposure Function (NEF) 182, a NF Repository Function (NRF) 184 a Network Slice Selection Function (NSSF) 186, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 184, which maintains a record of available NF instances and supported services. The NRF 184 allows other NF instances to subscribe and be notified of registrations from NF instances of a given type. The NRF 184 supports service discovery by receipt of discovery requests from NF instances and, in response, details which NF instances support specific services.

The NSSF 186 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 162 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 168 and then requests an appropriate network slice of the NSSF 186.

The UDM 168 introduces a User Data Convergence (UDC) that separates a User Data Repository (UDR) for storing and managing subscriber information. As such, the UDM 168 can employ the UDC under 3GPP TS 22.101 to support a layered architecture that separates user data from application logic. The UDM 168 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 168 can contain voluminous amounts of data that is accessed for authentication. Thus, the UDM 168 is analogous to a Home Subscriber Server (HSS), to provide authentication credentials while being employed by the AMF 170 and SMF 174 to retrieve subscriber data and context.

The PCF 172 can connect with one or more application functions (AFs) 188. The PCF 172 supports a unified policy framework within the 5G infrastructure for governing network behavior. The PCF 172 accesses the subscription information required to make policy decisions from the UDM 168, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 184. This allows the SCP to become the delegated discovery point in a datacenter, offloading the NRF 184 from distributed service meshes that make-up a network operator's infrastructure. Together with the NRF 184, the SCP forms the hierarchical 5G service mesh.

The AMF 170 receives requests and handles connection and mobility management while forwarding session management requirements over the N11 interface to the SMF 174. The AMF 170 determines that the SMF 174 is best suited to handle the connection request by querying the NRF 184. That interface and the N11 interface between the AMF 170 and the SMF 174 assigned by the NRF 184, use the SBI 181. During session establishment or modification, the SMF 174 also interacts with the PCF 172 over the N7 interface and the subscriber profile information stored within the UDM 168. Employing the SBI 181, the PCF 172 provides the foundation of the policy framework which, along with the more typical QoS and charging rules, includes Network Slice selection, which is regulated by the NSSF 186.

The AMF 170 and the UDM 168 can facilitate the attachment or registration of the wireless device 162 to the network, in accordance with one or more embodiments described herein. For example, the AMF 170 can receive an attach or registration request from a base station (e.g., gNB of RAN 164), where the request includes UE capability information. The AMF 170 then communicates with the UDM 168 over the N8 interface to update the wireless device 162's location. The UDM 168 can store the UE capability information and provide the information to the AMF 170 for resource allocation, service optimization, and mobility management tasks.

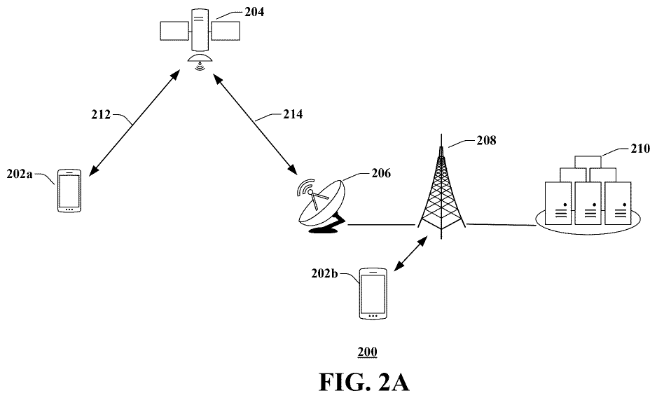

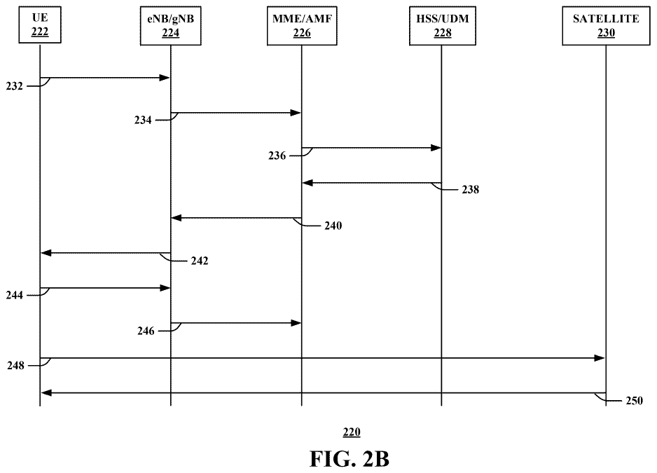

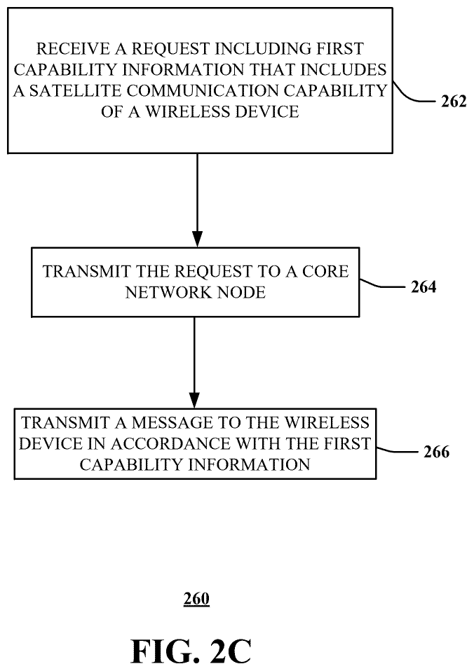

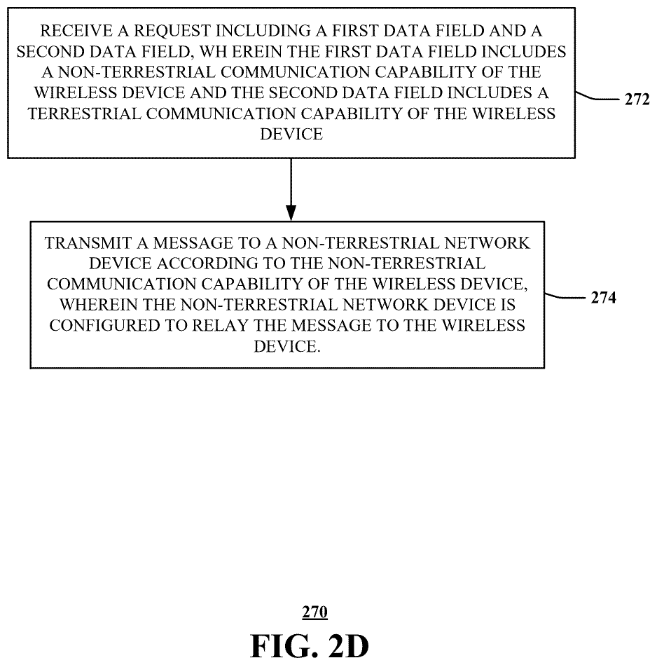

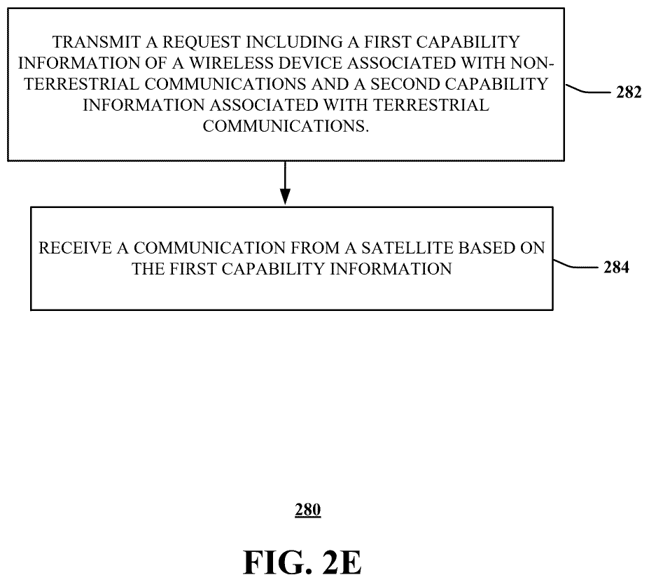

Referring now to FIG. 2A, a block diagram illustrates an example, non-limiting embodiment of a communications system 200 in accordance with various aspects described herein. The system 200 includes UEs 202a and 202b (e.g., device 124), a non-terrestrial network device 204, a non-terrestrial gateway 206, a BS 208 (e.g., BS 122), and a core network 210 (e.g., architecture 160 within communications network 125).

The system 200 depicts, but is not limited to, two UEs 202a and 202b, which represent devices such as smartphones or other wireless communication devices, such as vehicles, aircraft, computers, etc. The UEs 202a and 202b can wirelessly communicate with terrestrial network devices, non-terrestrial network devices, or both. For example, when terrestrial connectivity is unavailable, such as in remote or rural areas, or during emergency situations like natural disasters, the UE 202a can access a satellite connection provided by the NTN device 204. As shown, the UE 202a communicates directly with an NTN device 204 via a service link 212, while the UE 202b communicates with the terrestrial BS 208.

The NTN device 204 can be implemented as a satellite, such as a low-earth orbit (LEO), medium earth orbit (MEO), or geostationary orbit (GEO) satellite. Alternatively, the NTN device 204 may be a high-altitude platform station (HAPS), an unmanned aerial vehicle (UAV), or another suitable device for NTN systems.

The NTN device 204 is wirelessly connected to the network infrastructure through a feeder link 214, which establishes communication between the NTN device 204 and an NTN gateway 206. The NTN gateway 206 facilitates the transfer of data between the NTN device 204 and the core network 210. In some embodiments, collectively, the NTN device 204 and the gateway 206 may be referred to as the “satellite eNodeB (eNB)” for 4G LTE implementations or “satellite gNodeB (gNB)” for 5G NR implementations.

The NTN gateway 206 is connected to the core network 210, which represents the primary system responsible for managing network functions, data routing, and service delivery. Communication between the NTN gateway 206 and the central network infrastructure 210 can occur directly or through the BS 208. The BS 208 may be physically separated from or co-located with the NTN gateway 206, depending on the specific network architecture.

Referring now to FIG. 2B, a signaling flow diagram is shown illustrating an example, non-limiting embodiment of a communication procedure 220 for signaling non-terrestrial capability information, in accordance with various aspects described herein. The diagram depicts the interaction between a UE 222 (e.g., 124, 162, 202a, or 202b), an eNodeB/gNodeB 224, a Mobility Management Entity (MME)/Access and Mobility Management Function (AMF) 226, a Home Subscriber Server (HSS)/Unified Data Management (UDM) 228, and a satellite 230. The signaling flow demonstrates the process of attaching or registering a UE to an NTN, as well as the exchange of satellite-specific capability information.

The eNodeB/gNodeB 224 represents the base station functionality in the NTN system. In LTE (4G) networks, this is referred to as the eNodeB, which handles radio access and communication with the Mobility Management Entity (MME) in the core network. In 5G NR networks, this functionality is referred to as the gNodeB, which interfaces with the Access and Mobility Management Function (AMF) in the core network. Similarly, the MME 226 is a core network entity in LTE systems responsible for managing mobility and session control, while the AMF 226 serves a similar purpose in 5G NR systems, providing enhanced capabilities for handling network slicing and user plane selection. Regarding the HSS/UDM 228, the HSS (Home Subscriber Server) is a core network component in LTE networks, responsible for storing subscriber data and authentication credentials. In 5G NR networks, this functionality is handled by the UDM (Unified Data Management), which introduces additional features such as user data convergence and support for network slicing. Note that while FIG. 2B uses 4G and 5G terminology, embodiments of the present technology are not limited to these specific elements and other base stations and core network architectures and functions can be used.

The UE 222 first transmits an attach or registration request 232 to the eNodeB/gNodeB 224. The request 232 includes both general UE capability information (e.g., applicable to terrestrial communications) and non-terrestrial capability information (e.g., satellite-specific capability information). The non-terrestrial capability information may include at least one of the following:

Supported Spectrum Bands: e.g., NTN, LTE, or 5G spectrum bands supported by the UE 222.

Firmware Compatibility or Operating System: Current and supported firmware versions within the UE 222. This is beneficial because NTN access may be limited to specific firmware versions (e.g., by the network provider). Similarly, NTN access or functionality can be limited based on the operating system of the UE 222.

Access Types: Radio Access Types supported (e.g., LTE, NR, or satellite RAT).

Satellite Parameters: e.g., specific Packet Data Convergence Protocol (PDCP) parameters or other satellite parameters.

Carrier Aggregation (CA): Carrier aggregation combinations supported over satellite.

Security Algorithms: Supported security algorithms applicable to satellite communication (e.g., SHA 256, AES, RSA, etc.)

Network Slicing or UE Route Selection Policy (URSP) Capabilities: Slicing and User Plane Selection Policy (URSP) capabilities applicable to satellite communication.

Based on these capabilities, the network can adapt satellite communications to the UE 232. For example, the network can utilize the non-terrestrial capability information provided by the UE 222 to optimize communication, resource allocation, and service delivery for satellite communications.

In some embodiments, the network uses the capability information to optimize resource allocation for satellite communication. For example, the capability information in the request 232 can indicate supported satellite spectrum bands indicated by the UE 222, and the network can appropriately allocate the appropriate frequency bands for communication. In addition, the network can configure carrier aggregation combinations specific to satellite networks to maximize data throughput and optimize performance.

As another example, if the UE 222 indicates a particular RAT capability, the network can allocate resources for that RAT accordingly for other devices as well, such as restricting high-bandwidth services if the indicated RAT has low bandwidth availability and prioritizing essential services like voice calls or emergency communication.

In some embodiments, the network enforces access controls based on the UE's non-terrestrial capabilities. For instance, the network can restrict access to satellite networks for UEs running outdated operating systems to ensure compatibility and security. Similarly, the network can verify the UE's firmware version and restrict access if the firmware does not meet the minimum requirements for satellite communication. The network can also determine whether the UE supports satellite-specific Radio Access Technology (RAT) types and restrict access if the required RAT type is not supported. These access controls ensure that only compatible and secure devices can utilize satellite communication services.

In some embodiments, the network uses the capability information to enhance security measures for satellite communication. The network can apply encryption algorithms, such as TLS or SHA-256, based on the security algorithms supported by the UE. Advanced authentication protocols tailored to satellite communication can be implemented to ensure secure access for authorized devices. These security measures address unique challenges of satellite communication, such as the involvement of third-party satellite providers and the untrusted nature of satellite networks.

In some embodiments, the network utilizes the capability information to enable features such as network slicing and service differentiation. For example, the network can assign the UE 222 to a dedicated satellite network slice based on its reported slicing capabilities. The network can also map specific services to the UE 222's capabilities, such as enabling IoT applications or remote monitoring for UEs with advanced satellite capabilities. This allows the network to deliver tailored services that align with the UE's capabilities and user requirements.

In some embodiments, the network uses the capability information to manage handovers between terrestrial and satellite networks. The network can prepare for handovers by pre-configuring satellite-specific parameters based on the UE 222's capability information. This ensures seamless transitions between terrestrial and satellite coverage areas, minimizing service interruptions.

In some embodiments, the general UE capability information and the satellite specific capability information include the same types of capability information. For example, the UE 232 may use different carrier aggregation combinations for terrestrial communications than for satellite communications. Similarly, the UE 232 can use different PDCP configurations for satellite communications than for terrestrial communications.

In some embodiments, the attach or registration request 232 from the UE 222 can be transmitted to the satellite 230, which acts as a relay to forward the request to the eNodeB/gNodeB 224. For example, the satellite 230 establishes a service link (e.g., 212) with the UE 222 and a feeder link (e.g., 214) with a gateway (e.g., 206), enabling the request to traverse the satellite link and reach the MMF/AMF 226. This is useful in scenarios where the UE is located in remote or rural areas with no terrestrial base station coverage.

In some embodiments, where UE 222 has access to both terrestrial and satellite networks, the attach or registration request 232 can be transmitted directly to a terrestrial base station (e.g., 208). Transmitting the attach or registration request 232 to a terrestrial eNB/gNB 224 informs the network of non-terrestrial capability information of the UE 222, which enables the network to more efficiently communicate with the UE 222 when satellite communications are used. For example, the UE 222 may be traveling from an urban area with terrestrial network coverage to rural area with only satellite coverage. In this example, the UE 222 transmits the request 232 including satellite specific capability information to the terrestrial eNB/gNB 224 in the urban area. The network then uses the satellite specific capability information to facilitate the satellite connection in the rural area, such as by allocating resources based on supported CA.

In some embodiments, the UE 222 is configured to update its capability information. For example, the device manufacturer can push updates using a firmware over-the-air (FOTA) update mechanism. The updates can include enhancements to the device's non-terrestrial capabilities, such as support for new spectrum bands, improved security algorithms, or updated carrier aggregation configurations.

When the UE 222 updates its capability information, it can initiate additional requests to the network or satellite to communicate the updated capabilities. For example, the UE 222 can transmit a new attach or registration request 232 that includes the updated capability information. This allows the network to reassess the UE 222's capabilities and optimize resource allocation and service delivery accordingly.

The eNodeB/gNodeB 224 forwards the request at 234 to the MME/AMF 226. Upon receiving the forwarded attach or registration request 234, the MME/AMF 226 sends a update location request 236 (e.g., a tracking area update (TAU)) to the HSS/UDM 228. The update location request 236 can include the general UE capability information and/or the non-terrestrial capability information of the request 232. The HSS/UDM 228 processes the location update request and sends a location update acknowledgment 238 back to the MME/AMF 226, confirming that the UE's location has been successfully updated in the network's database.

The MME/AMF 226 then sends an attach or registration acceptance message 240 to the satellite eNodeB/gNodeB 224, which is forwarded 242 to the UE 222. This message indicates that the network has successfully processed the UE's request 232 and that the UE is now attached or registered to the NTN. The UE 222 responds with an attach or registration completion message 244, which is forwarded 246 by the satellite eNodeB/gNodeB 224 to the MME/AMF 226. This step finalizes the attach or registration process, enabling the UE to access NTN services. The general UE capability information and the non-terrestrial UE capability information are then stored by the core network for subsequent use.

In some embodiments, after the attach or registration process is complete, the UE 222 sends a capability request 248 to the satellite 230 to obtain specific satellite capability information. This request allows the UE to dynamically update its understanding of the satellite's capabilities, ensuring compatibility and optimal performance. The satellite 230 responds to the UE 222 with the requested capability information 250. This satellite's capability information may include details about supported spectrum bands, satellite-specific protocols, security algorithms, and other operational parameters. The capability response enables the UE 222 to adjust its communication settings to align with the satellite's capabilities, for example when the network provider or the satellite operator updates the satellite 230's capabilities.

The communication procedure 220 demonstrates the separation of non-terrestrial capability information from general UE capability information. This distinction allows the network to optimize resource allocation and manage UE behavior more effectively for non-terrestrial communications, such as in remote areas, during emergencies, and in mobility scenarios. By enabling efficient communication between the UE and the NTN, the procedure ensures uninterrupted service and optimized performance, even in challenging environments. In addition, the capability exchange between the UE and the satellite ensures that the UE can adapt to changes in satellite technology or network conditions.

FIG. 2C depicts an illustrative embodiment of a method 260 in accordance with various aspects described herein. The method 260 can be performed by a network device, such as BS 122, gateway 206, BS 208, or eNB/gNB 224. The method 260 can also be performed by a non-terrestrial network device, such as NTN device 204 or satellite 230.

At step 262, a request is received from a wireless device (e.g., 124, 162, 202a, 202b, or 222). This request includes first capability information, which specifies the satellite communication capabilities of the wireless device. The first capability information may include details such as supported spectrum bands, firmware compatibility, access types, carrier aggregation combinations, security algorithms, and network slicing capabilities. The request can be received directly or indirectly. For example, a satellite can directly receive the request from a UE, while a BS can directly receive the request from a UE within its cell or indirectly receive the request by relay from a satellite.

At step 264, the request from step 262 is transmitted the request to a core network node (e.g., within core network 210). The core network node can include MME/AMF 226, HSS/UDM 228, or any of the network functions in FIG. 1B. This step informs the core network of the wireless device's satellite communication capability, enabling the network to make informed decisions regarding resource allocation, service delivery, and security measures for the wireless device.

At step 266, as message is transmitted to the wireless device 250 in accordance with the first capability information. This message may include instructions, configurations, or acknowledgments tailored to the satellite communication capabilities of the device. For example, the message may specify the allocation of satellite spectrum bands, enable carrier aggregation for satellite links, or enforce security protocols based on the device's supported algorithms.

FIG. 2D depicts an illustrative embodiment of a method 270 in accordance with various aspects described herein. The method 270 can be performed by a network device, such as BS 122, gateway 206, BS 208, or eNB/gNB 224.

At step 272 a request is received from a wireless device. This request includes a first data field and a second data field, wherein the first data field includes non-terrestrial communication capability information and the second data field includes terrestrial communication capability information. The non-terrestrial communication capability information can refer to the capability of the wireless device to communicate with non-terrestrial devices, such as satellites, UAVs, and HAPs. The non-terrestrial communication capability information can include supported spectrum bands, firmware compatibility, access types, carrier aggregation combinations, security algorithms, and network slicing capabilities. The terrestrial communication capability information can include similar parameters used in terrestrial networks. This separation of capability information allows the network to distinguish between the wireless device's capabilities for terrestrial and non-terrestrial communication, facilitating optimized resource allocation and service delivery.

At step 274, a message is transmitted a non-terrestrial network device according to the non-terrestrial communication capability of the wireless device. The non-terrestrial network device (e.g., satellite 204) is configured to relay the message to the wireless device. For example, the message may be allocated according to satellite spectrum bands, carrier aggregation, or security protocols supported by the wireless device.

FIG. 2E depicts an illustrative embodiment of a method 280 in accordance with various aspects described herein. The method 280 can be performed by a wireless device, such as UE 124, UE 162, wireless device 202a or 202b, or UE 222.

At step 282, a request is transmitted that includes a first capability information associated with non-terrestrial communications and a second capability information associated with terrestrial communications. The first capability information may include satellite-specific parameters such as supported spectrum bands, firmware compatibility, access types, carrier aggregation combinations, security algorithms, and network slicing capabilities. The second capability information may include similar parameters used for terrestrial communications. By transmitting both types of capability information, the wireless device ensures that the network can distinguish between its terrestrial and non-terrestrial communication capabilities, enabling optimized resource allocation and service delivery.

At step 284, a communication is received from a satellite based on the first capability information. For example, the communication may be transmitted using resources determined according to the satellite spectrum bands or carrier aggregation capabilities included in the request at step 282, or enforce security protocols based on the wireless device's supported algorithms.

While for purposes of simplicity of explanation, the respective processes are shown and described as a series of blocks in FIGS. 2C-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

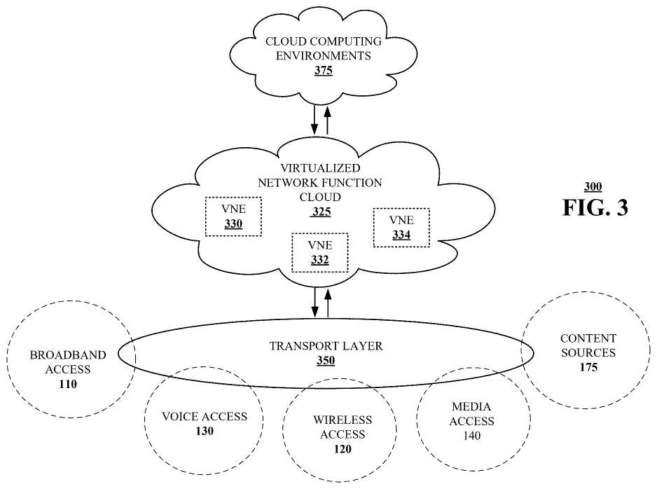

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, system 210, and communication procedure 220, and methods 260, 270, and 280 presented in FIGS. 1A, 1B, 2A, 2B, 2C, 2D, and 2E. For example, virtualized communication network 300 can facilitate in whole or in part exchange of satellite-specific capability information.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

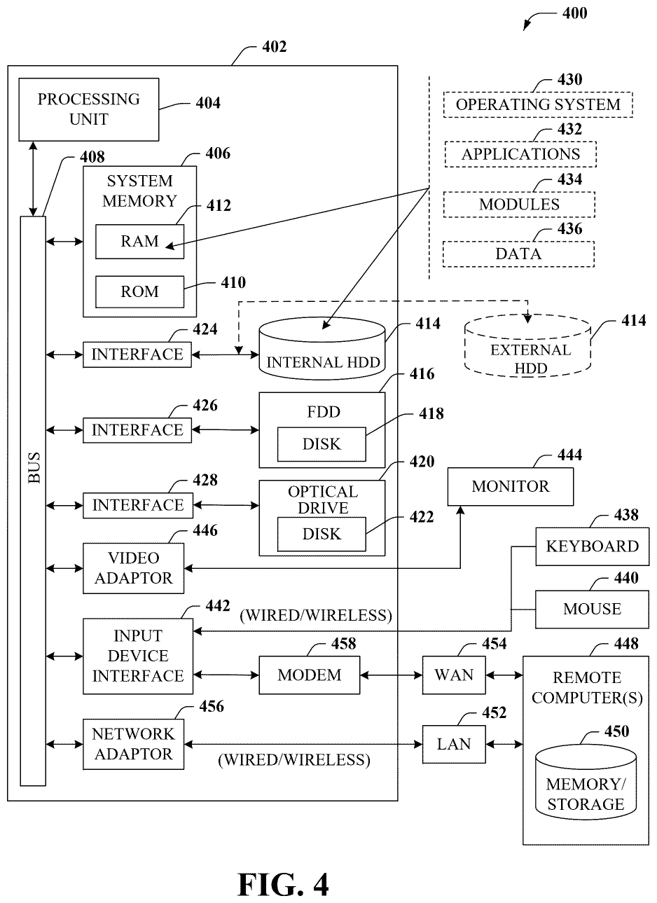

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part satellite-specific capability information.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

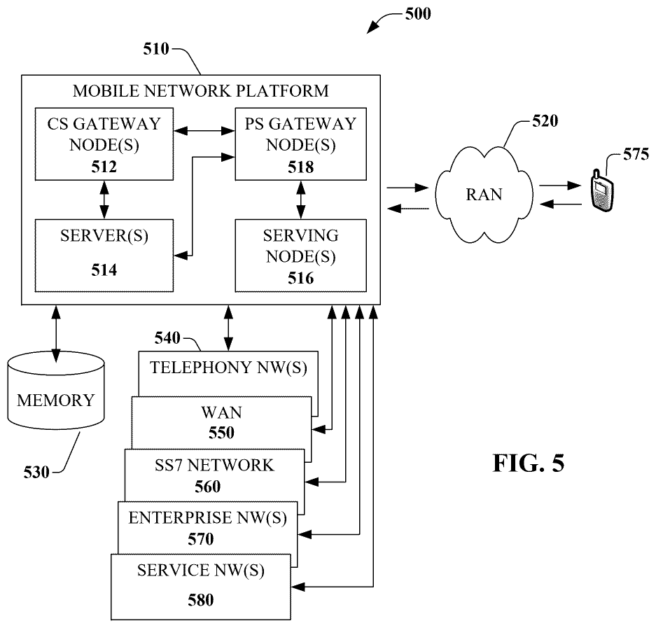

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part satellite-specific capability information. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1A that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

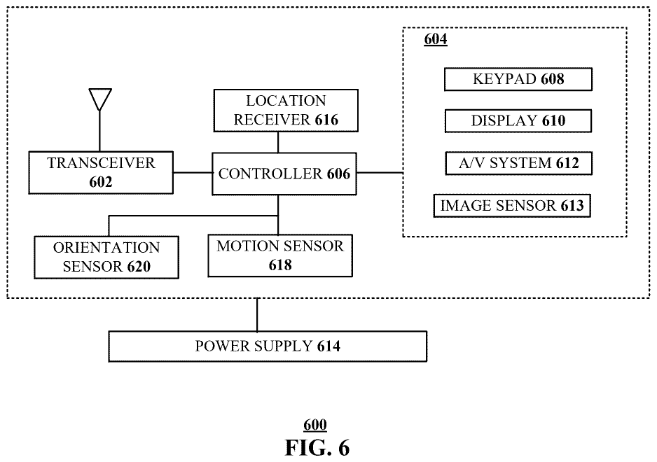

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part satellite-specific capability information.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with satellite-specific capability exchange) can employ various AI-based schemes for carrying out various embodiments thereof. For example, a classifier can be employed to determine a ranking or priority of UEs connected to a NTN. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which UEs will benefit from different allocations of resources in accordance with their reported capabilities.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
receiving, from a wireless device, a request including first capability information, wherein the first capability information includes a satellite-specific communication capability of the wireless device; and
transmitting, to the wireless device, a message in accordance with the first capability information.

2. The device of claim 1, wherein the request includes second capability information different from the first capability information, the second capability information including a terrestrial communication capability of the wireless device.

3. The device of claim 2, wherein the first capability information and the second capability information are included in separate fields of the request.

4. The device of claim 1, wherein the operations further comprise:
transmitting the first capability information to a core network node.

5. The device of claim 1, wherein the first capability information includes at least one of: a satellite access type, a firmware compatibility, a carrier aggregation information, or a network slice capability.

6. The device of claim 1, wherein the first capability information includes a security algorithm supported by the wireless device or an operating system version of the wireless device.

7. The device of claim 1, wherein the device is a non-terrestrial network device, and wherein the operations further comprise:
receiving the message from a terrestrial gateway prior to the transmitting the message.

8. The device of claim 1, wherein the device is a terrestrial network device, and wherein the transmitting the message includes:
transmitting the message to a non-terrestrial network device, wherein the non-terrestrial network device is configured to relay the message to the wireless device.

9. The device of claim 1, wherein the request includes a registration or attachment request.

10. The device of claim 1, wherein the device is a satellite, and wherein the operations further comprise:
receiving, from a network device, an update to a capability of the device, resulting in an updated capability; and
transmitting the updated capability to the wireless device.

11. A non-transitory machine-readable medium, comprising executable instructions that, when executed by a processing system including a processor, facilitate performance of operations, the operations comprising:
receiving, from a wireless device, a request including a first data field and a second data field, wherein the first data field includes a non-terrestrial communication capability of the wireless device and the second data field includes a terrestrial communication capability of the wireless device; and
transmitting, to a non-terrestrial network device, a message according to the non-terrestrial communication capability of the wireless device, wherein the non-terrestrial network device is configured to relay the message to the wireless device.

12. The non-transitory machine-readable medium of claim 11, wherein the operations further comprise:
forwarding the request to a core network node of a core network, the core network configured to store the non-terrestrial communication capability and the terrestrial communication capability.

13. The non-transitory machine-readable medium of claim 11, wherein the non-terrestrial communication capability includes at least one of: an access type, a firmware compatibility, an operating system version, a carrier aggregation information, or a network slice capability.

14. The non-transitory machine-readable medium of claim 11, wherein the non-terrestrial communication capability includes a security algorithm supported by the wireless device.

15. The non-transitory machine-readable medium of claim 11, wherein the operations further comprise:
transmitting, to the non-terrestrial network device, an update including an updated capability of the non-terrestrial network device,
wherein the non-terrestrial network device is configured to transmit the updated capability to the wireless device in response to receiving a capability request from the wireless device.

16. A method comprising:
transmitting, by a wireless device, a request including a first capability information of the wireless device associated with non-terrestrial communications and a second capability information of the wireless device associated with terrestrial communications; and
receiving, by the wireless device, a communication from a satellite based on the first capability information.

17. The method of claim 16, further comprising:
transmitting, by the wireless device to the satellite, a request for capability information of the satellite; and
receiving, by the wireless device, the capability information of the satellite.

18. The method of claim 16, wherein the first capability information includes at least one of: a supported band, a firmware compatibility, an access type, carrier aggregation information, a supported security algorithm, or a network slice capability.

19. The method of claim 16, wherein the first capability information and the second capability information are included in separate fields of the request.

20. The method of claim 16, wherein the request a first request, the method further comprising:
updating, by the wireless device, the second capability information, resulting in an updated second capability information; and
transmitting, by the wireless device, a second request including the updated second capability information.
